(19) United States
(12) Patent Application Publication
(10) Pub. No.: US 2017/0073790 A1
(43) Pub. Date: Mar. 16, 2017

(54) METHOD FOR FORMING POWER TRANSMISSION COMPONENTS USING HEAT-ASSISTED CALIBRATION PROCESS AND POWER TRANSMISSION COMPONENTS MADE USING METHOD

(71) Applicant: Magna Powertrain Inc., Concord (CA)

(72) Inventors: John R. SABO, Caledon (CA); Sokol SULAJ, Toronto (CA)

(21) Appl. No.: 15/123,701

(22) PCT Filed: Mar. 25, 2015
(86) PCT No.: PCT/CA2015/000175

§ 371 Date: Sep. 6, 2016

Related U.S. Application Data
(60) Provisional application No. 61/970,008, filed on Mar. 25, 2014.
(60) Provisional application No. 62/108,793, filed on Jan. 28, 2015.

(51) Int. Cl. C21D 9/32; B23P 15/14; C21D 1/74; C21D 1/673; C22C 38/04; F16H 41/24; F16H 39/08; F16H 57/08; F16H 57/037; F16H 57/032; F16H 57/04; B21D 53/28; F16D 23/00

(52) U.S. Cl. CPC C21D 9/32; B21D 53/28; B23P 15/14; C21D 1/74; C21D 1/673; C22C 38/04; F16D 23/00; F16H 39/08; F16H 57/082; F16H 57/037; F16H 57/032; F16H 57/0452; F16H 41/24; C21D 2221/00; F16D 2300/26

(57) ABSTRACT

A method for forming a component utilizing ultra-high strength steel and components formed by the method. The method includes the step of providing a flat blank of ultra-high strength 22MnB5 steel. The next step of the method is, cold forming the flat blank into an unfinished shape of a component while the blank is in an unhardened state. The method continues by providing an inert atmosphere. Then, heating the unfinished shape of the component in the inert atmosphere. The method proceeds by forming a finished shape of the component using a quenching die resulting in a fine-grained martensitic component material structure and enabling net shape processing to establish fmal geometric dimensions of the components.

### CROSS REFERENCE TO RELATED APPLICATIONS

This PCT application claims the benefit of, and priority to, U.S. Provisional Application Ser. No. 61/970,008 filed Mar. 25, 2014, and also to U.S. Provisional Patent Application Ser. No. 62/108,793, filed Jan. 28, 2015, the entire disclosures of each of which are incorporated herein by reference.

### FIELD

The present disclosure relates generally to components formed from ultra-high strength steel, such as boron steel, and method of forming the same.

### BACKGROUND

Ultra-high strength steel is currently used in building construction and static automotive structures (e.g. vehicle bodies and frames). The use of ultra-high strength steel generally allows the weights of these structures to be reduced. Additionally, in automotive structures, the ultra-high strength steel enables the absorption of impact energy and minimizes intrusion into occupant seating areas. Although ultra-high strength steel can be made extremely strong, other properties such as formability, weldability, and impact toughness may be negatively affected, resulting in structures which may be more prone to cracking and fracture.

Power transmission components for automotive vehicles, such as clutch assemblies having clutch plates within a clutch housing and clutch hub are well-known. Such clutch housings have a generally cylindrical or cup-shaped body and an open end. The cylindrical or cup-shaped body is formed from a sheet metal blank and has a plurality of spline teeth formed thereon. The clutch plates fit within the clutch housing and engage the spline teeth. The clutch hub can also be a formed sheet metal component and is typically connected to a transmission shaft.

Powertrain components including clutch housings and hubs are commonly made of aluminum or high strength low alloy steel (HSLA) rather than ultra-high strength steel, such as boron steel. Aluminum or HSLA steel is used primarily because of its formability. Specifically, these types of materials are high strength materials which can achieve a specific geometric dimension or shape and have a specific tolerance required. Consequently, aluminum or HSLA may be used in powertrain components including parts of an automatic transmission easily, efficiently, and at a low-cost.

Typically, components such as clutch housings and hubs made of aluminum or HSLA are formed using one or a combination of cold-forming or stamping processes and thermal heat treatments to obtain the desired shape, performance, and strength characteristics. Additionally, the structures such as the plurality of spline teeth of the clutch housing may be formed easily by using a series of rollers. Similar processes also may be used to form other powertrain components such as planetary carriers used in differentials and various covers used in a vehicle powertrain.

Ultra-high strength steel lacks formability using the conventional cold-forming technologies discussed above. Use of conventional cold-forming technologies with ultra-high strength steel typically does not result in the formation of required geometric dimensions and tolerances. However, there is a desire by manufacturers and suppliers to utilize ultra-high strength steel in forming automotive components such as power transmission components for similar reasons as those discussed above when used in static applications of automotive structures (e.g. reduced component weight and improved absorption of impact energy).

As such, a need exists for components, such as clutch housings and hubs, to be formed from ultra-high strength steel, such as boron steel. Additionally, there is a need for a method for forming the same.

### SUMMARY

This section provides a general summary of the inventive concepts associated with the present disclosure and is not intended to represent a comprehensive disclosure of its full scope or all of its features, object, aspects and advantages. Components formed with ultra-high strength steel and a method of forming these components from ultra-high strength steel are provided.

In accordance with an aspect of present disclosure, a method for forming a component utilizing ultra high strength steel includes the steps of providing a flat blank of ultra high strength steel. The method proceeds by forming the flat blank into an unfinished shape of a component. Next, the method includes the steps of providing an inert atmosphere and heating the unfinished shape of the component in the inert atmosphere. Then, forming a finished shape of the component using a quenching die.

In accordance with an aspect of present disclosure, a component of ultra high strength steel is produced by providing a flat blank of ultra high strength steel. Next, forming the flat blank into an unfinished shape of the component. This is followed by providing an inert atmosphere and heating the unfinished shape of the component in the inert atmosphere. Then, forming a finished shape of the component using a quenching die so as to obtain the component.

In accordance with an exemplary embodiment of a component constructed in accordance with the present disclosure, there is provided a clutch housing. The clutch housing has a cylindrical or cup-shaped body and an open end.

In accordance with this exemplary embodiment of the present disclosure, a method for forming the clutch housing from ultra-high strength steel includes cold-forming the body of the clutch housing, heat treating in an inert atmosphere, and quenching using a water cooled quenching die to form and finalize the cylindrical or cup-shaped body. The ultra-high strength steel forming the body of the clutch housing may be boron steel.

In accordance with this exemplary embodiment of the present disclosure, the method for forming components from ultra-high strength steel includes pre-forming or cold-forming a flat blank of steel into a predetermined shape. The predetermined shape may be a cylindrical or cup-shaped body. The step of cold-forming the flat blank of steel may include forming a plurality of spline teeth along the blank of steel. The method may also include heat treating the blank of steel in an inert atmosphere. The inert atmosphere may be an induction oven or an induction chamber. Additionally, heat treating may be partially or completely localized. The method further includes quenching the heat treated blank of steel. Quenching may include forming a plurality of spline teeth along the blank of steel or finalizing the predetermined form using a water cooled quenching die.

In accordance with this exemplary embodiment of the present disclosure, the method for forming components from ultra-high strength steel includes heat treating a blank of steel in an inert atmosphere and quenching the heat treated blank into a predetermined shape.

In accordance with a second embodiment of a component constructed in accordance with the present disclosure, there is provided a clutch hub. The clutch hub has a cup-shaped body and an open end.

In accordance with a third embodiment of a component constructed in accordance with the present disclosure, there is provided a continuously variable transmission (CVT) plunger. The CVT plunger includes a generally bell-shaped body defining a centrally disposed opening.

In accordance with a forth embodiment of a component constructed in accordance with the present disclosure, there is provided a CVT cylinder. The CVT cylinder includes an annular or cylindrically shaped body having a first end and a second end and including a shoulder formed at the first end.

In accordance with a fifth embodiment of a component constructed in accordance with the present disclosure, there is provided a planetary carrier. The planetary carrier comprises a first piece and a second piece joined together by a weld. The first piece includes a plurality of legs extending longitudinally. A plurality of apertures are circumferentially disposed in a spaced relationship to each other about the perimeter of each piece.

In accordance with a sixth embodiment of a component constructed in accordance with the present disclosure, there is provided a reaction shell. The reaction shell comprises a body including a cylindrical first portion of a first diameter and a cylindrical second portion of a second diameter being larger than the first diameter. A plurality of radially outwardly extending spline teeth are disposed about the cylindrical second portion.

In accordance with a seventh embodiment of a component constructed in accordance with the present disclosure, there is provided a differential housing. The differential housing is generally cup or drum shaped with a tubular neck portion defining a central opening a plurality of arms extending radially and longitudinally from the neck portion.

In accordance with a eighth embodiment of a component constructed in accordance with the present disclosure, there is provided a differential cover. The differential cover comprises a generally bell shaped body extending between a generally cylindrical first end and an opposite annular second end. A ring gear is attached to the second end of the cover.

In accordance with an ninth embodiment of a component constructed in accordance with the present disclosure, there is provided a torque converter cover. The torque converter cover comprises a front portion and a back portion. The front portion is generally drum-shaped and includes a radial wall and an integral cylindrical portion with an inner surface that extends longitudinally from the radial wall. The back portion is ring shaped and has a center opening and a curved cross-section or half round shape.

In accordance with a tenth embodiment of a component constructed in accordance with the present disclosure, there is provided an oil pan. The oil pan comprises a generally rectangular base with a side wall disposed around the periphery of the base and extending generally perpendicularly from the base to an upper continuous flange adapted to be secured under the block of an engine.

The aspects disclosed herein provide various advantages. For example, the components are more lightweight as a result of a reduced cross section resulting from increased material strength than conventional components using HSLA steel. The components have increased tolerance from using ultra-high strength steel than conventional components. The method is more cost efficient and reduces cost due to component trimming using water cooled quenching unlike the conventional methods which require additional trimming such as laser trimming. In other words, there is a reduced die wear and maintenance based on the resulting lower cutting forces from using water cooled quenching. Additionally, there is an improved component reliability due to the reduction of crack initiations due to soft component trimming and an increased manufacturing flexibility using localized induction heating.

### DRAWINGS

Other advantages of the present disclosure will be readily appreciated, as the same becomes better understood by reference to the following detailed description when considered in connection with the accompanying drawings wherein:

FIG. 1 is a perspective view of a clutch housing and a clutch hub in accordance with an exemplary embodiment of the present disclosure;

FIG. 2 is a cross-sectional view along 2-2 of FIG. 1;

FIG. 3 is a perspective view of a clutch housing having a plurality of spline teeth for engaging a clutch plate in accordance with the exemplary embodiment of the present disclosure;

FIG. 4 is a flowchart of a method for forming a power transmission component utilizing ultra-high strength steel in accordance with the exemplary embodiment of the present disclosure;

FIG. 5 is a flowchart of a method for forming a power transmission component utilizing ultra-high strength steel in accordance with the exemplary embodiment of the present disclosure;

FIG. 6 is a flowchart of a method for forming a power transmission component utilizing ultra-high strength steel in accordance with the exemplary embodiment of the present disclosure;

FIG. 7 is a flowchart of a method for forming a power transmission component utilizing ultra-high strength steel in accordance with the exemplary embodiment of the present disclosure;

FIG. 8 is a perspective view of a clutch hub in accordance with a second embodiment of the present disclosure;

FIG. 9 is a perspective view of a continuously variable transmission (CVT) plunger in accordance with a third embodiment of the present disclosure;

FIG. 10 is a perspective view of a CVT cylinder in accordance with a fourth embodiment of the present disclosure;

FIG. 11 is a perspective view of a planetary carrier in accordance with a fifth embodiment of the present disclosure;

FIG. 12A is a perspective view of a reaction shell in accordance with a sixth embodiment of the present disclosure;

FIG. 12B is a perspective view of a reaction shell in accordance with the sixth embodiment of the present disclosure;

FIG. 13A is a perspective view of a differential housing in accordance with a seventh embodiment of the present disclosure;

FIG. 13B is a cross-sectional view along 13B-13B of FIG. 13A;

FIG. 13C is a cross-sectional view along 13C-13C of FIG. 13A;

FIG. 14 is a perspective view of a differential cover in accordance with a eighth embodiment of the present disclosure;

FIG. 15A is a perspective view of a torque converter cover in accordance with a ninth embodiment of the present disclosure;

FIG. 15B is a front view of a front portion of the torque converter cover shown in FIG. 15A;

FIG. 15C is a front view of a back portion of the torque converter cover shown in FIG. 15A; and

FIG. 16 is a perspective view of an oil pan in accordance with a tenth embodiment of the present disclosure.

### DETAILED DESCRIPTION

Detailed examples of the present disclosure are disclosed herein; however, it is to be understood that the disclosed examples are merely exemplary and may be embodied in various and alternative forms. It is not intended that these examples illustrate and describe all possible forms of the disclosure. Rather, the words used in the specification are words of description rather than limitation, and it is understood that various changes may be made without departing from the spirit and scope of the disclosure.

The aspects disclosed herein include components made of ultra-high strength steel and a method of forming components utilizing ultra-high strength steel. In particular, the components may be for example, lightweight automatic clutch hubs and housings, planetary gear carriers, or torque convertor covers made of boron steel and cold formed in their unhardened state to near net-shape via an “indirect method” and finished sized i.e. net-shaped via heat assisted calibration (HAC) to achieve 40 to 60% mass reduction of rotating inertia. According to an aspect, the lightweight pre-formed boron steel components (with or without a plurality of spline teeth) are subsequently heated in an inert atmosphere and rapidly transferred to a water-cooled quenching die to minimize oxidation and resulting in a fine-grained martensitic component material structure. The die quenching tool enables net shape processing within geometric dimensions and tolerance requirements.

As those of ordinary skill in the art will understand various features of the present disclosure as illustrated and described with reference to any of the Figures may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations.

Example embodiments of components formed from ultra-high strength steel constructed in accordance with the present disclosure will now be more fully described. These example embodiments are primarily directed to powertrain components. Moreover, each of the exemplary embodiments is provided so that this disclosure is thorough and fully conveys the scope of the inventive concepts, features and advantages to those skilled in the art. To this end, numerous specific details are set forth to provide a thorough understanding of each of the embodiments associated with the present disclosure. However, as will be apparent to those skilled in the art, not all specific details described herein need to be employed, the example embodiments may be embodied in many different forms, and that neither should be construed or interpreted to limit the scope of the disclosure.

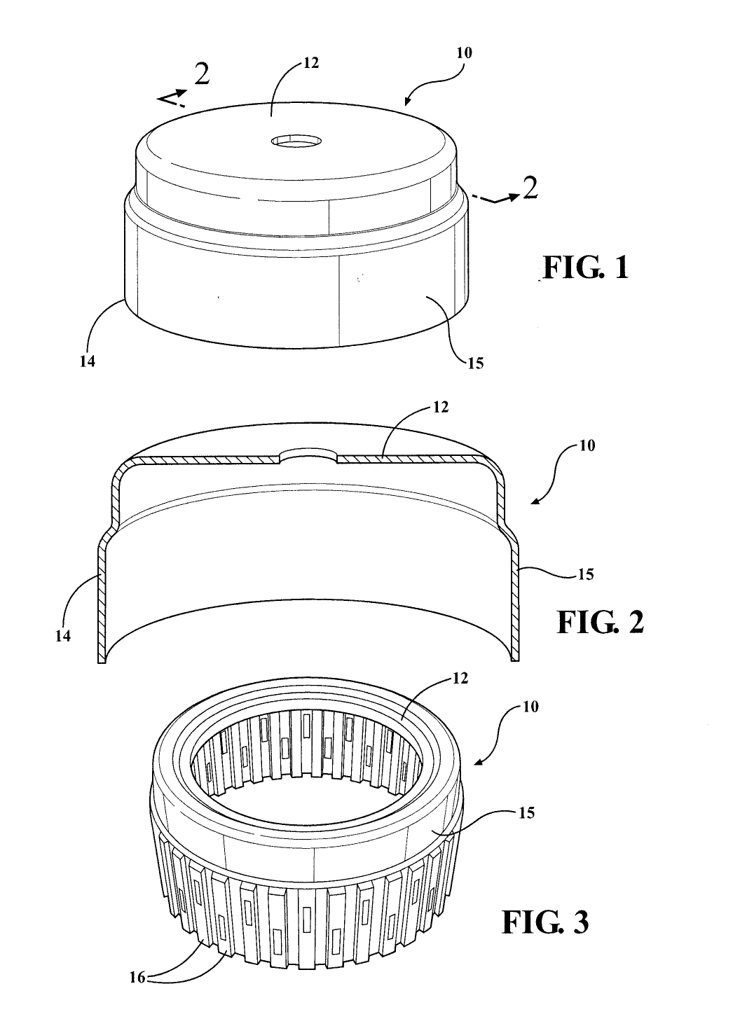

FIGS. 1-3 show various views of a clutch housing 10 in accordance with an exemplary embodiment of the present disclosure. In particular, FIG. 1 shows a perspective view of a clutch housing 10, FIG. 2 shows a cross-sectional view of the clutch housing 10 and hub 12, and FIG. 3 shows a perspective view of the clutch housing 10 having a plurality of spline teeth 16 disposed thereon. In FIGS. 1 and 2, the clutch housing 10 is shown without the plurality of spline teeth 16. The clutch housing 10 has a generally cylindrical or cup-like shape having a radial ring portion 12 and a cylindrical drum portion 15. Housing 10 is formed from a strip (i.e. blank) of ultra-high strength steel 14, one preferred type of ultra-high strength steel 14 includes 22MnB5 boron steel. The ultra-high strength steel may be pre-coated with aluminum silicon (AlSi) or other material to prevent corrosion and decarburization during the heating and quenching steps. The clutch housing 10 may be a single piece or may be two pieces joined together by a weld or may be pressed-formed. To form the clutch housing 10, a blank of boron steel 14 is preformed, specifically cold-formed, into a predetermined shape. The predetermined shape may be a cylindrical shape or any shape known in the art related for clutch housings. After the blank 14 is cold-formed into a predetermined shape, the predetermined shape is heat treated in an inert environment. The inert environment may be an induction oven or induction chamber. Heat treatment may include, but is not limited to, any or a combination of annealing, case hardening, tempering, quenching, hot forming, or welding. Next, the clutch housing 10 is exposed to a water cooled quenching tool die to form a plurality of spline teeth 16 thereon, as shown in FIG. 3. Alternatively, the water cooled quenching die may form a second predetermined shape instead of a plurality of spline teeth 16, as shown in FIGS.1-2 where the clutch housing 10 is smooth. It is important to note in FIG. 2 that the cross-sectional view shows a reduction in materials used compared to conventional methods using HSLA steel. A clutch hub may be formed in the same manner as will be described further below.

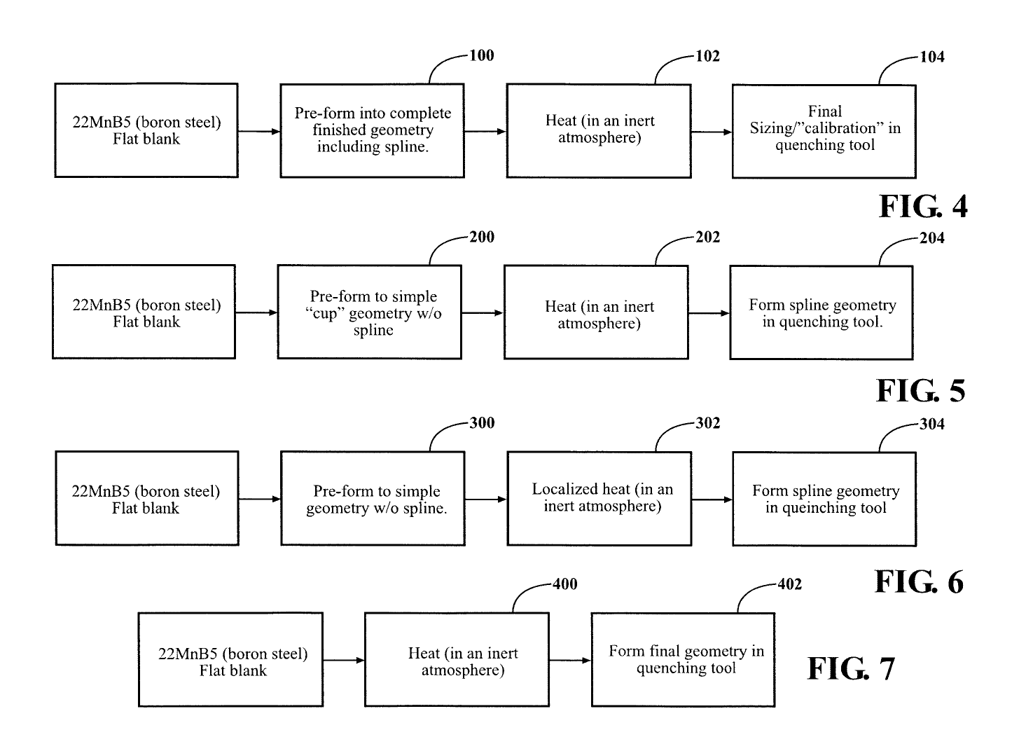

With respect to FIG. 4, a flowchart of a method for forming a component utilizing ultra-high strength steel in accordance with the exemplary embodiment of the present disclosure is provided. As illustrated by additional embodiments described in more detail below, the component may be, but is not limited to, a clutch housing, clutch hub, planetary gear carrier, or a torque converter cover. In the exemplary embodiment, the component is the clutch housing 10 described above. First, the method includes the 100 pre-forming a flat blank of steel into a predetermined shape having a plurality of spline teeth 16. Specifically, the pre-forming of the flat blank of steel is carried out by cold-forming techniques. The predetermined or unfinished shape is based on the type of component. For example, if the component is a clutch housing 10, the steel may be cold-formed into a cylindrical or cup-like shape. The flat blank of steel may be 22MnB5 boron steel and may be pre-coated to prevent corrosion. After the flat blank of steel has been pre-formed into a predetermined shape with the plurality of spline teeth 16, the pre-formed predetermined shape is 102 heat treated in an inert atmosphere to alter the properties of the steel. The heat treated steel is then sized and calibrated using a quenching tool 104. In particular, a water cooled quenching die.

With respect to FIG. 5, a flowchart with a method for forming a component utilizing ultra-high strength steel in accordance with the exemplary embodiment of the present disclosure is provided. The method includes 200 pre-forming a flat blank of steel into a cup-shaped body. As discussed above, the flat blank of steel may be a 22MnB5 boron steel blank. The cup-shaped body is then 202 heat treated in an inert environment. The inert environment may be an induction chamber or oven. Next, the method includes 204 water cooled quenching the cup-shape body to form a plurality of spline teeth thereon.

FIGS. 6-7 also show flowcharts of methods for forming a component utilizing ultra-high strength steel in accordance with the exemplary embodiment of the present disclosure. Like the methods shown in FIGS. 4-5, the methods shown in FIGS. 6-7 utilize 22MnB5 boron steel. However, it is appreciated by one skilled in the art that any type of ultra-high strength steel or any type of boron steel may be used in conjunction with these methods. In FIG. 6, the method includes 300 pre-forming or cold-forming the flat blank of steel into a predetermined shape. The predetermined or unfinished shape of the method shown in FIG. 6 does not include a plurality of spline teeth 16. The cold-formed steel is then 302 heat treated in an inert atmosphere. The heat treatment may be localized to a certain portion of the steel. The method further includes 304 forming a plurality of spline teeth 16 within the heat treated steel using a quenching tool. The quenching tool is a water-cooled quenching die.

With respect to FIG. 7, the method for forming a component utilizing ultra-high strength steel in accordance with the exemplary embodiment of the present disclosure includes 400 heat treating a flat blank of steel in an inert atmosphere and 402 quenching the heat treated flat blank into a predetermined shape using a quenching tool.

The method discussed above may also include, but is not limited to cold-forming the clutch housing 10 without a plurality of spline teeth 16, heat treating the unfinished shape of the clutch housing 10 using localized induction heating, and forming and sizing the plurality of spline teeth 16 using the quenching die. Alternatively, the method may include pre-forming/cold-forming the clutch housing 10 with a plurality of spline teeth 16, heating the unfinished shape of the clutch housing 10 in an inert environment, and sizing and finalizing the shape of the housing 10 in the quenching die. Similarly, planetary gear carriers and other components may be partially or completely cold formed and then heated using either localized or entire part heating.

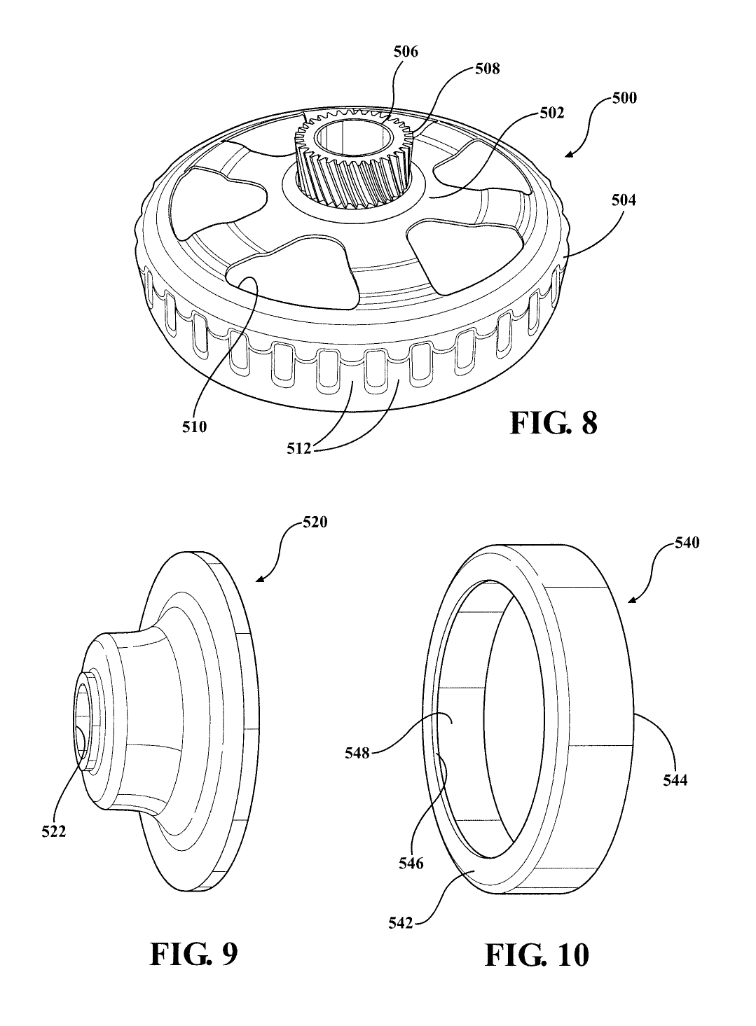

In addition to the clutch housing 10 disclosed above, other embodiments of components from ultra-high strength steel constructed in accordance with the present disclosure are described in more detail below. FIG. 8 shows a clutch hub 500 in accordance with a second embodiment of the present disclosure. The clutch hub 500 has a cup-like shape having a radial ring portion 502 and a cylindrical drum portion 504. A tubular neck 506 extends longitudinally from the radial ring portion 502 and a drive gear 508 is attached to the tubular neck 506. Like the clutch housing 10, the clutch hub 500 may be formed from a strip (i.e. blank) of ultra-high strength steel. The ultra-high strength steel may also be pre-coated with aluminum silicon (AlSi) or other material to prevent corrosion and decarburization during the heating and quenching steps. The clutch hub 500 may be a single piece or may be two pieces joined together by a weld or may be pressed-formed. To form the clutch hub 500, a blank of boron steel can be cold-formed into a predetermined or unfinished shape. A plurality of generally triangular openings 510 can be formed in the radial ring portion during cold forming for weight reduction. The predetermined shape may then be heat treated in an inert environment. Next, the clutch hub 500 may be exposed to a water cooled quenching tool die to form a plurality of radially outwardly extending spline teeth 512 disposed about the cylindrical drum portion 504.

FIG. 9 shows a continuously variable transmission (CVT) plunger 520 in accordance with a third embodiment of the present disclosure. The CVT plunger 520 includes a generally bell-shaped body defining a centrally disposed opening 522. The CVT plunger 520 is formed from a preformed flat blank of ultra-high strength steel, preferably 22MnB5 boron steel. The blank of boron steel may be cold-formed into a predetermined or unfinished shape with a thick center and outer edge. The predetermined shape shape can then be heat treated in an inert environment. Next, the CVT plunger 520 can be exposed to a water cooled quenching tool die.

FIG. 10 shows a CVT cylinder 540 in accordance with a fourth embodiment of the present disclosure. The CVT cylinder 540 includes an annular or cylindrically shaped body having a first end 542 and a second end 544 and including a shoulder 546 formed at the first end 542. The body of the CVT cylinder 540 defines an opening 548 longitudinally extending from the first end 542 to the second end 544. The CVT cylinder 540 begins as a preformed flat blank of ultra-high strength steel, preferably 22MnB5 boron steel, with the centrally disposed material removed and discarded. Next, the preformed blank or unfinished shape is heat treated in an inert environment. Then, the CVT cylinder 540 is exposed to a water cooled quenching tool die.

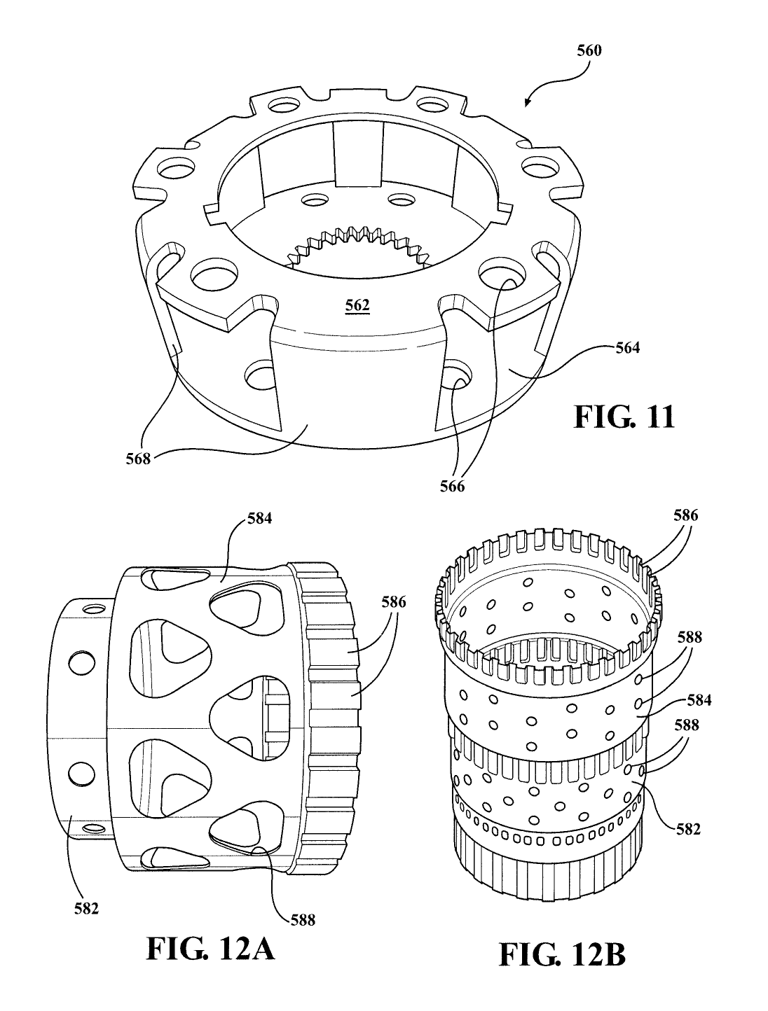

FIG. 11 shows a planetary carrier 560 in accordance with a fifth embodiment of the present disclosure. The planetary carrier 560 comprises a first piece 562 and a second piece 564 joined together by a weld. A plurality of apertures 566 are circumferentially disposed in a spaced relationship to each other about the perimeter of each piece 562, 564. The first piece 562 includes a plurality of legs 568 extending longitudinally. To form the first piece 562 of the planetary carrier 560, a flat blank of boron steel can be cold-formed into a predetermined or unfinished shape with the plurality of apertures 566 and including the legs 568. To form the second piece 564 of the planetary carrier 560, a flat blank of boron steel can be cold-formed into a an unfinished shape with the plurality of apertures 566. The unfinished shapes of the pieces 562, 564 are heat treated in an inert environment. Next, each piece 562, 564 of the carrier 560 may be exposed to a water cooled quenching tool die. The planetary carrier 560 is completed by joining or welding the legs 568 of the first piece 562 to the second piece 564.

FIGS. 12A and 12B show two reaction shells 580 in accordance with a sixth embodiment of the present disclosure. Each reaction shell 580 comprises a body including a cylindrical first portion 582 of a first diameter and a cylindrical second portion 584 of a second diameter being larger than the first diameter. A plurality of radially outwardly extending spline teeth 586 are disposed about the cylindrical second portion 584. A plurality of bores 588 are defined by the cylindrical first portion 582 and the cylindrical second portion 584. To form the reaction shell 580, a flat blank of boron steel is cold-formed into a predetermined tubular shape or unfinished shape having the bores. The predetermined tubular shape is then heat treated in an inert environment. Although the bores 588 are formed while cold-forming, it should be understood that the bores 588 may also be formed while the predetermined tubular shape is hot. Next, the reaction shell is exposed to a water cooled quenching tool die to hold the geometry and form the radially outwardly extending spline teeth 586 disposed about cylindrical second portion 584.

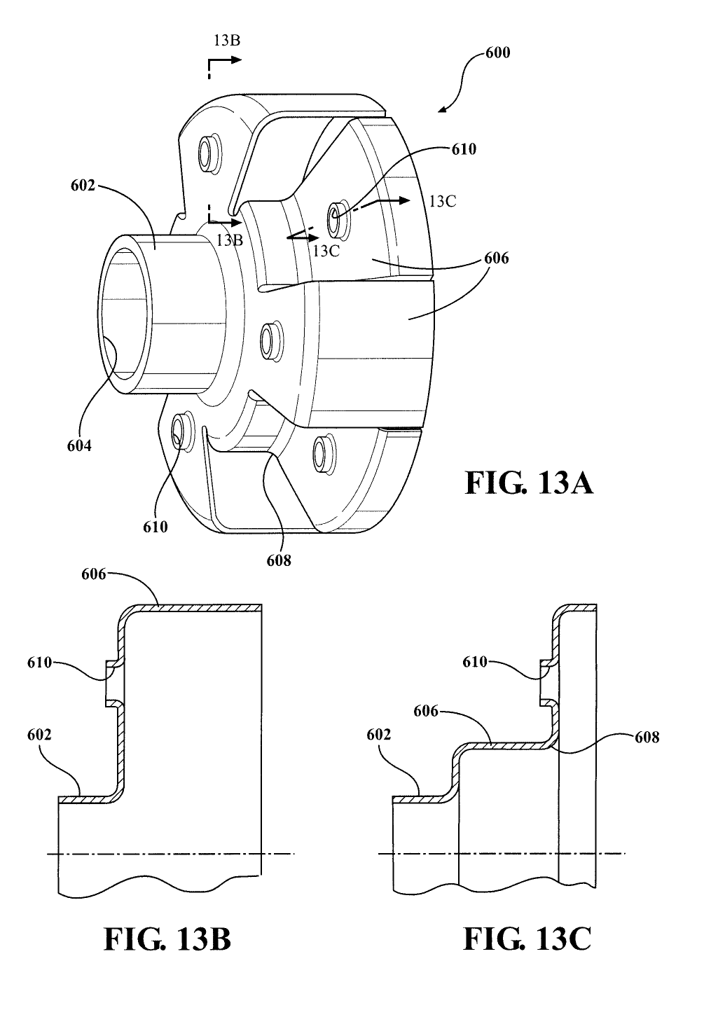

FIG. 13A shows a differential housing 600 in accordance with a seventh embodiment of the present disclosure. The differential housing 600 is generally cup or drum shaped with a tubular neck portion 602 defining a central opening 604 and including a plurality of arms 606 extending radially and longitudinally from the neck portion 602. The arms 606 alternate circumferentially between the arm 606 including a radially inwardly extending shoulder 608 (FIG. 13C) and the arm 606 having a generally L shaped cross section (FIG. 13B). Each arm 606 also includes at least one aperture 610. The differential housing 600 begins as a preformed flat blank of ultra-high strength steel, preferably 22MnB5 boron steel, with an extrusion forming the neck portion 602 and the central opening 604. The preformed blank or unfinished shape is heat treated in an inert environment. Then the differential housing 600 is exposed to a water cooled quenching tool die.

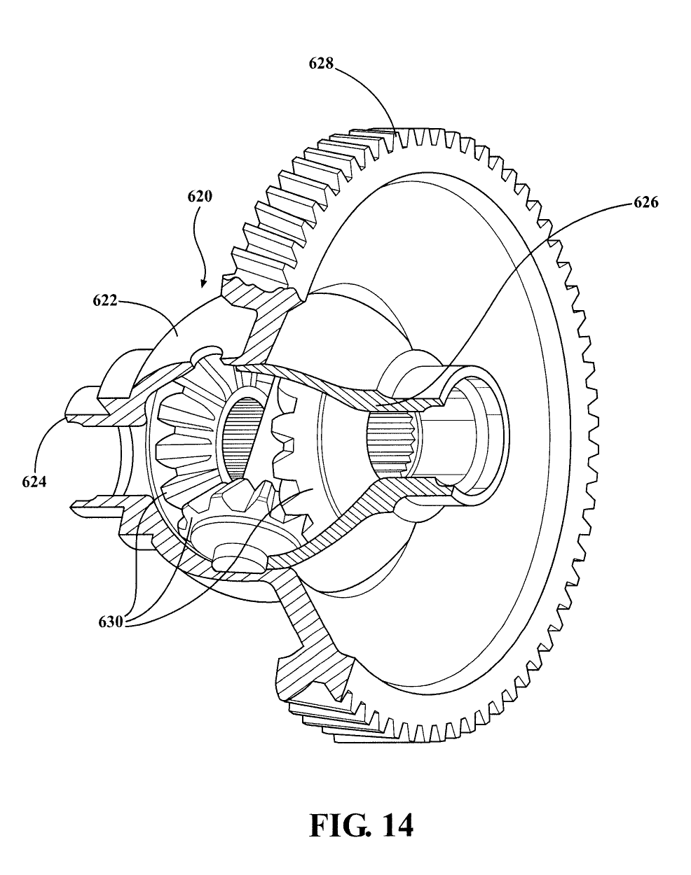

FIG. 14 shows a differential cover 620 in accordance with an eighth embodiment of the present disclosure. The differential cover 620 comprises a generally bell shaped body 622 extending between a generally cylindrical first end 624 and an opposite annular second end 626. A ring gear 628 is attached to the second end 626 of the cover 620. The cover 620 is for enclosing a plurality of pinion gears 630. The cover 620 is formed with a flat blank of boron steel that is cold-formed into a unfinished flat or cup shape having an extrusion extending longitudinally at its center. Next, the cover 620 is heat treated in an inert environment. Then the cover 620 is exposed to a water cooled quenching tool die. The ring gear 628 may initially be two pieces which are welded to the outer diameter of the cover 620.

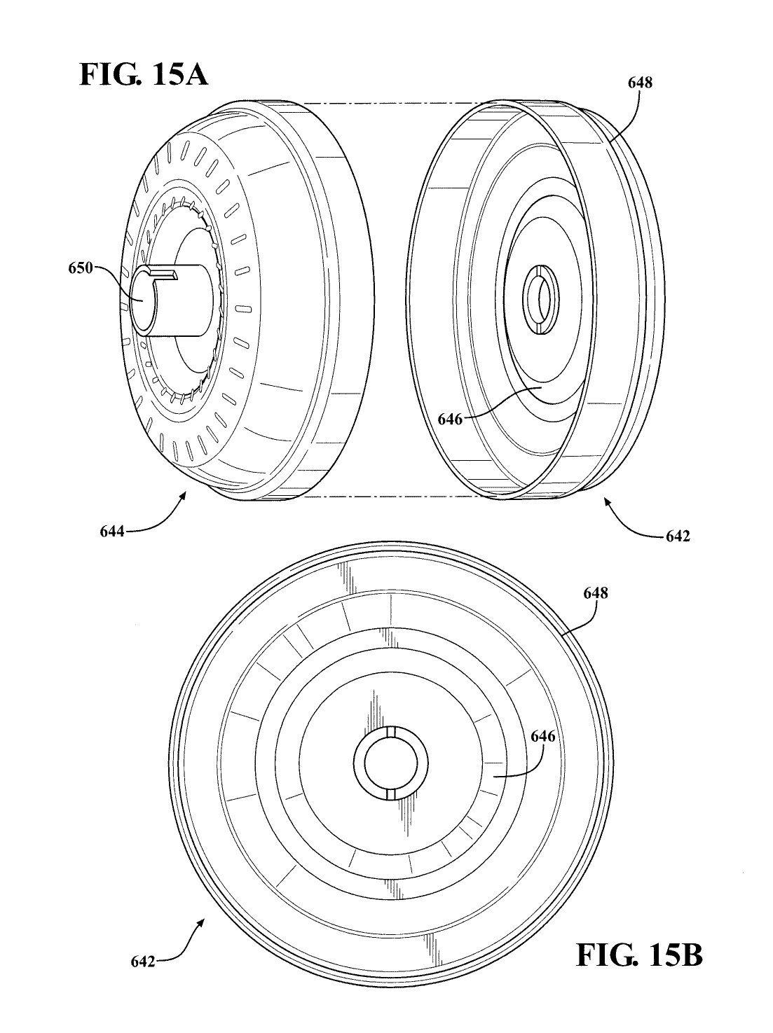

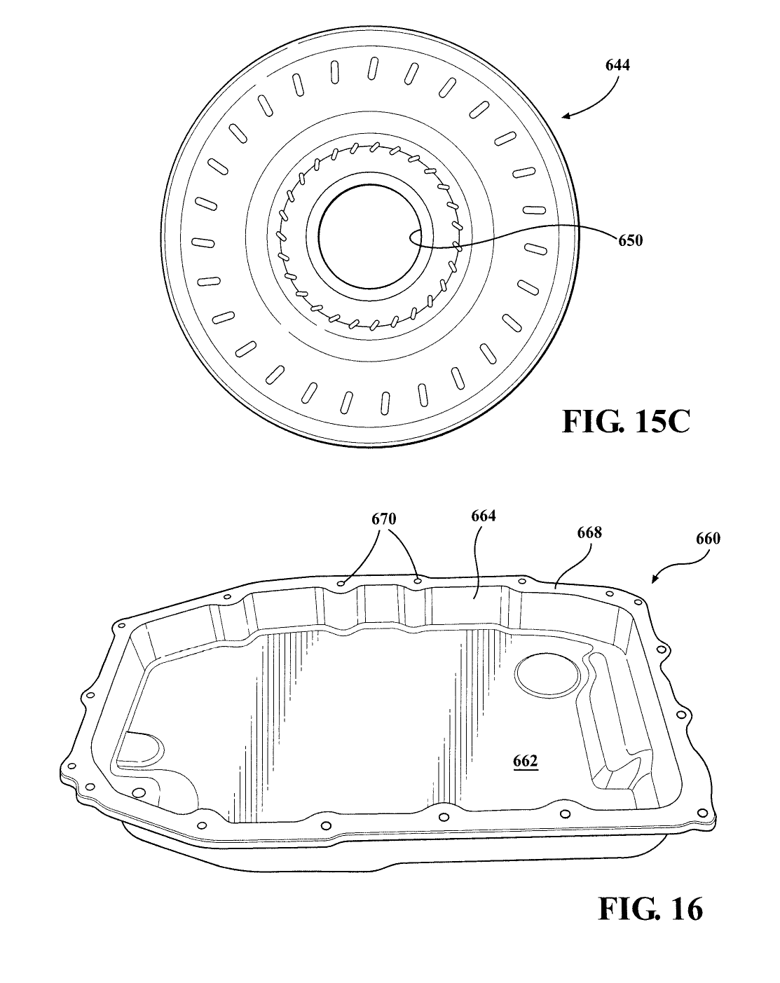

FIG. 15A shows a torque converter cover 640 in accordance with a ninth embodiment of the present disclosure. The torque converter cover 640 comprises a front portion 642 (FIG. 15B) and a back portion 644 (FIG. 15C). The front portion 642 is generally drum-shaped and includes a radial wall 646 having an outer peripheral portion defining a lock-up surface. An integral cylindrical portion 648 of the front portion 642 has an inner surface that extends longitudinally from the radial wall 646. The inner surface of the front portion may also define an internal spline. The back portion 644 is ring shaped and has a center opening 650 and a curved cross-section or half round shape. Each portion 642, 644 begins as a flat blank of boron steel which is cold-formed into a predetermined shape. The predetermined or unfinished shapes may then be heat treated in an inert environment. Next, each portion 642, 644 of the cover can be exposed to a water cooled quenching tool die. Such torque converter covers 640 using higher strength steel allow for a thinner wall which reduces weight compared to covers made from other materials.

FIG. 16 shows an oil pan 660 in accordance with a tenth embodiment of the present disclosure. The oil pan 660 comprises a generally rectangular base 662 with a side wall 664 disposed around the periphery of the base 662 and extending generally perpendicularly from the base 662 to an upper continuous flange 668 adapted to be secured to a block of an engine. A plurality of openings 670 are defined by the flange 668 and spaced from each other circumferentially about the flange 668. The oil pan 660 may be formed from a flat blank of boron steel which is cold-formed into a predetermined shape. The predetermined or unfinished shape may then be heat treated in an inert environment. Then the oil pan 660 can be exposed to a water cooled quenching tool die. The use of high strength steel in this type of application allows for a thinner base 662 and side wall 664 and can also allow for ribbing features.

In each embodiment of the present disclosure, the components may be formed from 22MnB5 steel, however, it should be understood that the amount of boron (B5-B50) may be selected depending on the type of component or strength desired. Additionally, the amount of other materials which comprise the ultra-high strength steel, such as carbon, may cause variation in the martensitic percentage and hardness after quenching. During the heat treatment, the heating temperature is approximately 850-950degrees C. More specifically, the target heating temperature for 22MnB5 steel is 900 degrees C., however, the heating temperature may be increased as the amount of boron is increased. As described above, the heat treating may be partially or completely localized. The heating method may be induction or by other techniques. When it is desirable to localize strength in one particular area of a component, the heat treatment may be localized to that area. In other instances, localized heat treatment may be used for sections of a component having a thicker cross section.

During the quenching step that may be used in forming each embodiment of the present disclosure, the quench press/die defines the final shape of the part. The release temperature may range between approximately 150-250 degrees C., with a preferred target temperature of 200 degrees C. The components generally remain in the quench press/die for approximately 6-20 seconds depending on the cross sectional thickness and desired strength.

In general, materials having a strength of approximately 1000 Mpa will crack or spring back during cold forming, therefore the methods described in the present disclosure are advantageous when forming such high strength materials. Additionally, due to a reduction of cross section, the geometry of components formed with heat assisted calibration (HAC) methods disclosed herein may be more complex (i.e. ribs). Consequently, the manufacturing of some components (e.g. planetary carrier described in the fifth embodiment above) that is not possible using cold forming is made possible with HAC processes.

While examples of the disclosure have been illustrated and described, it is not intended that these examples illustrate and describe all possible forms of the disclosure. Rather, the words used in the specification are words of description rather than limitation, and it is understood that various changes may be made without departing from the spirit and scope of the disclosure. Additionally, the features and various implementing embodiments may be combined to form further examples of the disclosure.

1. A method for forming a component utilizing ultra-high strength steel including the steps of:
providing a flat blank of ultra-high strength steel;
forming the flat blank into an unfinished shape of a component;
providing an inert atmosphere;
heating the unfinished shape of the component in the inert atmosphere; and
forming a finished shape of the component using a quenching die.

2. The method as set forth in claim 1 wherein the step of heating the unfinished shape of the component in the inert atmosphere is further defined as heating the unfinished shape of the component in the inert atmosphere at a temperature between 850 degrees Celsius and 950 degrees Celsius.

3. The method as set forth in claim 1 wherein the step of forming a finished shape of the component using a quenching die is further defined as forming a finished shape of the component using a quenching die while cooling the component to a temperature between 150 degrees Celsius and 250 degrees Celsius.

4. The method as set forth in claim 1 wherein the step of forming the flat blank into an unfinished shape of a component further includes the step of forming a plurality of spline teeth in the unfinished shape.

5. The method as set forth in claim 1 wherein the step of forming a finished shape of the component using a quenching die is further defined as forming a finished shape of the component using a quenching die while forming a plurality of spline teeth in the component using the quenching die.

6. The method as set forth in claim 1 wherein the step of heating the unfinished shape of the component in the inert atmosphere is defined as locally heating at least one particular area of the unfinished shape in the inert atmosphere to localize strength in the particular area of the component.

7. The method as set forth in claim 1 further including the step of coating the flat blank of ultra-high strength steel with aluminum silicon to prevent corrosion and decarburization as the ultra-high strength steel is heated.

8. The method as set forth in claim 1 wherein the flat blank of ultra-high strength steel is of the 22MnB5 ultra high strength steel type.

9. A component of ultra-high strength steel being produced by:
providing a flat blank of ultra-high strength steel;
forming the flat blank into an unfinished shape of the component;
providing an inert atmosphere;
heating the unfinished shape of the component in the inert atmosphere; and
forming a finished shape of the component using a quenching die so as to obtain the component.

10. The component as set forth in claim 9 wherein the component is a clutch housing and the flat blank is a strip of ultra-high strength steel and the component is further produced by forming the unfinished shape into a cylindrical shape having a radial ring portion and a cylindrical drum portion and forming a plurality of spline teeth in the cylindrical drum portion of the clutch housing using the quenching die while forming the finished shape.

11. The component as set forth in claim 9 wherein the component is a clutch hub and the flat blank is a strip of ultra-high strength steel and the component is further produced by forming the unfinished shape into a cylindrical shape having a radial ring portion and a cylindrical drum portion and including a tubular neck and forming a plurality of generally triangular openings in the radial ring portion of the unfinished shape and forming a plurality of spline teeth in the cylindrical drum portion of the clutch hub using the quenching die while forming the finished shape and attaching a drive gear to the tubular neck.

12. The component as set forth in claim 9 wherein the component is a CVT plunger and is further produced by forming the unfinished shape with a thick center and a thick outer edge and forming the finished shape of a generally bell-shaped body defining a centrally disposed opening with the quenching die.

13. The component as set forth in claim 9 wherein the component is a CVT cylinder and is further produced by removing centrally disposed material from the flat blank and forming the unfinished shape into a cylindrical shaped body having a first end and a second end and a shoulder formed at the first end and an opening longitudinally extending from the first end to the second end.

14. The component as set forth in claim 9 wherein the component is a planetary carrier having a first piece and a second piece and is further produced by forming the first piece into the unfinished shape with a plurality of apertures circumferentially disposed in a spaced relationship about the first piece and including a plurality of legs extending longitudinally and forming the second piece into the unfinished shape with a plurality of apertures circumferentially disposed in a spaced relationship about the second piece and joining the first piece with the second piece after forming the finished shape of the first piece and the finished shape of the second piece using the quenching die.

15. The component as set forth in claim 9 wherein the component is a reaction shell and is further produced by forming the unfinished shape into a body having a cylindrical first portion of a first diameter and a cylindrical second portion of a second diameter being larger than the first diameter and forming a plurality of bores in the cylindrical first portion and in the cylindrical second portion and forming a plurality of radially outwardly extending spline teeth in the cylindrical second portion of the reaction shell using the quenching die while forming the finished shape.

16. The component as set forth in claim 9 wherein the component is a differential housing and is further produced by forming the unfinished shape into a drum shape with a tubular neck portion defining a central opening and including a plurality of arms extending radially and longitudinally from the neck portion and wherein the arms alternate circumferentially between the arm including a radially inwardly extending shoulder and the arm having a generally L shaped cross section and forming at least one aperture in each of the arms.

17. The component as set forth in claim 9 wherein the component is a differential cover for enclosing a plurality of pinion gears and is further produced by forming the unfinished shape into a bell shaped body extending between a generally cylindrical first end and an opposite annular second end and attaching a ring gear to the tubular neck following forming the finished shape using the quenching die.

18. The component as set forth in claim 9 wherein the component is a torque converter cover having a front portion and a back portion and is further produced by forming the front portion into the unfinished shape having a general drum shape including a radial wall having an outer peripheral portion defining a lock-up surface and an integral cylindrical portion having an inner surface extending longitudinally from the radial wall and forming the back portion into the unfinished shape having a ring shape with a center opening and a curved cross section and forming a plurality of spline teeth in the inner surface of the front portion using the quenching die while forming the finished shape of the front portion.

19. The component as set forth in claim 9 wherein the component is an oil pan and is further produced by forming the unfinished shape into a generally rectangular base with a side wall disposed around the periphery of the base and extending generally perpendicularly from the base to an upper continuous flange adapted to be secured to a block of an engine and forming a plurality of openings defined by the flange and spaced from each other circumferentially about the flange.

20. The component as set forth in claim 9 wherein the ultra-high strength steel is of the 22MnB5 type.
